(19) United States
(12) Patent Application Publication
(10) Pub. No.: US 2005/0178619 A1
(43) Pub. Date: Aug. 18, 2005

(54) Lubrication module of linear guideway

(76) Inventors: Liao Chi-Meng, Taichung (TW); Chen Scotte, Taichung (TW)

Correspondence Address: CHARLES E. BAXLEY, ESQ., 90 JOHN STREET, THIRD FLOOR, NEW YORK, NY, 10038, US

(21) Appl. No.: 10/781,547

(22) Filed: Feb. 17, 2004

(51) Int. Cl. F16N 1/00

(52) U.S. Cl. 184/5

(57) ABSTRACT

The present invention relates to a lubrication module of linear guideway, the lubrication module which was made up of the oil-storage box and the oil-bearing material. The characteristic of the lubrication module of linear guideway is that the lubrication module be installed in the sliding block, and it can lubricate the roller directly by the oil-bearing material, therefore can save the space and reduce the waste of the lubricant.

### BACKGROUND OF THE INVENTION

1. Field of the Invention

The present invention relates to a lubrication module, and more particularly to a lubrication module of linear guideway capable of lubricating the rollers in a direct manner, the linear guideway is widely applied to mechanical arm, machines, auto equipment, measurement equipment and electronic equipment, and the likes.

2. Description of the Prior Arts

Currently, linear guideway has been applied to precision machinery and general machines, and generally there are two kinds of method for lubricating the linear guideway: first one as shown in FIG. 6, wherein the lubrication system is mounted on both end cups 53 of a sliding block 54, and the lubricant is stored in the oil box 52. And then smear the rolling passage (not shown) of the linear guideway with hair felt 51, so as to lubricate the rollers 55 indirectly when the rollers 55 roll through the rolling passage. The second lubricating methods as shown in FIG. 7, wherein oil-bearing material 63 is mounted on the circulating device 62 at both ends of the sliding block 61 in a manner that the oil-bearing material 63 directly contacts the surface of the rolling passage of the rail 64, so as to smear the lubricant of the oil-bearing material 63 on the surface of the rolling passage. In this case, the second method also is indirect lubrication.

The above two methods suffer from one or more of the following disadvantages:

First, the lubrication system of the both methods will extend the length of the sliding block, such that the effective travel of the linear guideway is relatively shortened.

Second, both of the methods lubricate the rollers by smearing lubricant on the rolling passage not directly on the rollers, and thus lubricant consumption is increased.

Furthermore, the replenishment of the lubricant in the oil-bearing material can only be achieved by disassembling the linear guideway and replacing the oil-bearing material, so it is low efficiency and not good for environmental protection.

The present invention has arisen to mitigate and/or obviate the afore-described disadvantages of the conventional lubrication system for linear guideway.

### SUMMARY OF THE INVENTION

The primary object of the present invention is to provide a lubrication module of linear guideway capable of lubricating the rollers in a direct manner, and thus the efficiency is improved while the lubricant consumption is reduced. The self-lubrication system is defined with oil-storage space without extending the length of the sliding block, such that the effective travel of the linear guideway is not shortened.

Since the linear guideway has been widely used in general mechanics and precision machinery, with the rapid growth of the science and technology, the linear guideway has to overcome some problems caused by high speed, and lubrication is one of the key problems.

First, in order to improve the efficiency of lubrication, the present invention uses the improved direct lubrication mehtod instead of conventional method of indirect lubrication (the method of lubricating the roller directly). To enable the lubrication module of the present invention to lubricate the roller directly, the lubrication module should be installed in the scope of the circumrotate way of the roller, that is on the periphery of the sliding block.

Second, in order not to reduce the effective travel after the linear guideway is provided with lubrication module, the lubrication module of the present invention is disposed on the circumrotate way of the roller at the periphery of the sliding block of the linear guideway. In this case, it will not increase the length of the sliding block and accordingly the effective travel of the linear guideway will not be reduced.

The lubrication module of the present invention is designed to match the shape of the sliding block and interiorly defined with an oil-storage space for the storage of lubricating oil, such that not only space is saved but also the whole structure of the slide block can be unchanged. Thereby, without changing the sizes of the machine and the linear guideway, it can be conveniently replaced with the linear guideway with self-lubrication of the present invention.

Furthermore, in order to introduce the lubricating oil in the lubrication module to the surface of the roller in the circumrotate way, an oil-bearing material is provided in the oil-storage space of the lubrication module, wherein the oil-bearing material is able to lubricate the roller by capillary action so as not only to prevent the waste of the lubricant, but also to prolong the service life of the linear guideway. The oil-bearing material in accordance with the present invention can be in form of felt, flannelet, cotton, sponge and the likes.

In addition, for easy assembly, the oil-storage space of the lubrication module of the present invention is comprised of two elements, the two elements are assembled together using ultrasonic bonding method, such that the tightness is good and cost is lower, so as to prevent oil leakage.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a perspective view of a linear guideway with self-lubrication system in accordance with an embodiment of the present invention;

FIG. 2 is an assembly view of the sliding block equipped with the self-lubrication system in accordance with the present invention;

FIG. 3 is an exploded view of the lubrication module of linear guideway in accordance with the present invention;

FIG. 4 is an assembly view of the lubrication module of linear guideway in accordance with the present invention;

FIG. 5 is a cross sectional view taken along with the line A-A in FIG. 2;

FIG. 6 is an illustrative view of a conventional lubrication system for linear guideway;

FIG. 7 is an exploded view of another conventional lubrication system for linear guideway.

### DETAILED DESCRIPTION OF THE PREFERRED EMBODIMENT

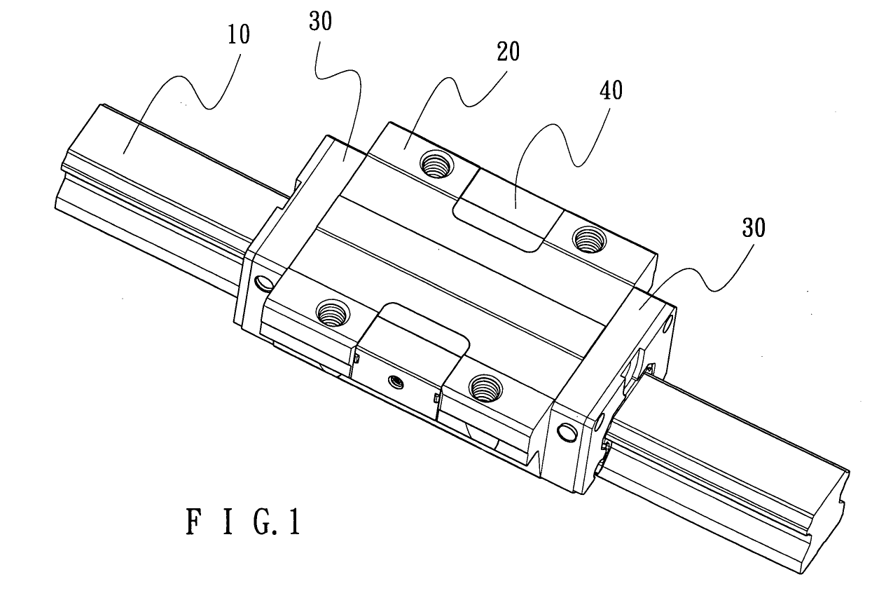

FIG. 1 is a perspective view of a linear guideway with self-lubrication system in accordance with an embodiment of the present invention; wherein a sliding block 20 is mounted on a rail 10, and at both ends of the sliding block 20 is provided with a circulating device 30 respectively so as to make the rollers (not shown) circulate in the sliding block 20, such that the sliding block 20 is able to move circularly along the rail 10. In this embodiment, the sliding block 20 is further provided at both sides thereof with a self-lubrication module 40 for lubricating the rolling members in the sliding block 20.

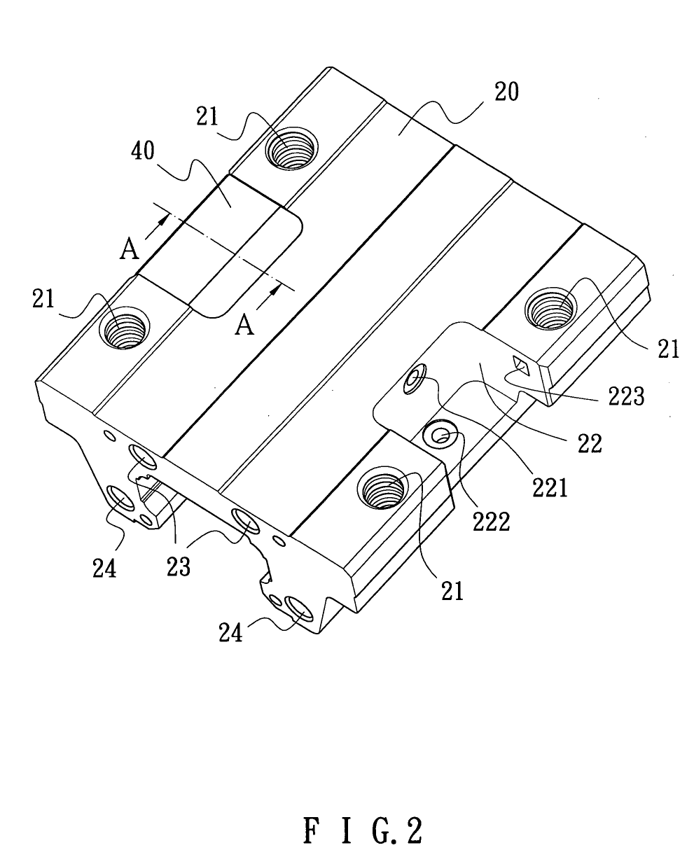

FIG. 2 is an assembly view of the sliding block equipped with the self-lubrication system in accordance with the present invention. Wherein at least one recess 22 is defined at both sides of the sliding block 20 and located adjacent to threaded holes 21 for reception of the self-lubrication module 40. An upper and a lower lubricating holes 221, 222 corresponding to upper passage 23 and lower passage 24 respectively are defined in the recess 22, such that the rollers in the upper and the lower passages 23, 24 can be lubricated by the self-lubrication module 40. Furthermore, the self-lubrication module 40 is mounted to the sliding block 20 using a tongue and groove method. In this case, engaging groove 223 is defined in the recess 22 for engaging with the tongue structure of the self-lubrication module 40.

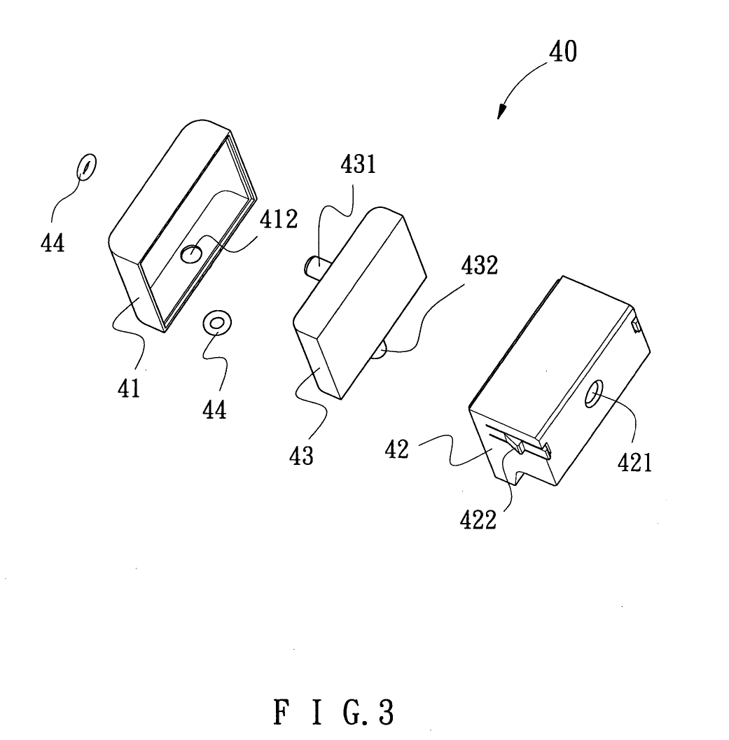

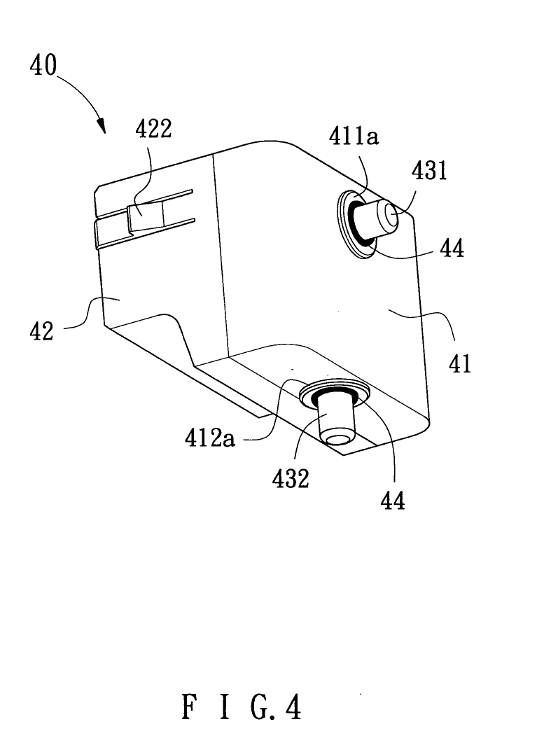

FIG. 3 is an exploded view of the lubrication module of linear guideway in accordance with the present invention. FIG. 4 is an assembly view of the lubrication module of linear guideway in accordance with the present invention. Wherein the self-lubrication module generally comprises oil-storage box (not shown) and oil-bearing material 43. The oil-storage box (not shown) is interiorly provided with an oil-storage space and designed as having a front cover 41 and a rear cover 42 for easy production, and the front and the rear covers 41, 42 can be assembled together using ultrasonic bonding method. The oil-bearing material 43 is received in the oil-storage box for absorbing the lubricating-oil in the oil-storage box and lubricating the rollers. The front cover 41 is defined with an upper aperture (not shown) and a lower aperture 412. And the upper and the lower apertures are provided with an upper protrusion 411a and a lower protrusion 412a respectively around the periphery thereof for positioning purpose. Both the upper and the lower apertures are provided with an oil-seal loop 44 for improving the effect of oil-seal. On the rear cover 42 is defined with a replenishing pipe 421, such that it is in line with environmental protection standards and convenient that the self-lubrication module 40 can be replenished with lubrication without assembly or disassembly. At both sides of the rear cover 42 are provided with an elastic piece 422 that serves to engage in the engaging groove 223 of the sliding block 20, such that it is convenient for assembly and disassembly. Furthermore, the oil-bearing material 43 is provided with an upper flange 431 and a lower flange 432 for insertion through the oil-seal loop 44, the lower and the upper apertures respectively, such that after the assembly of the self-lubrication module 40, the oil-bearing material 43 is connected to the oil-storage space and the rollers so as to lubricate the rollers directly.

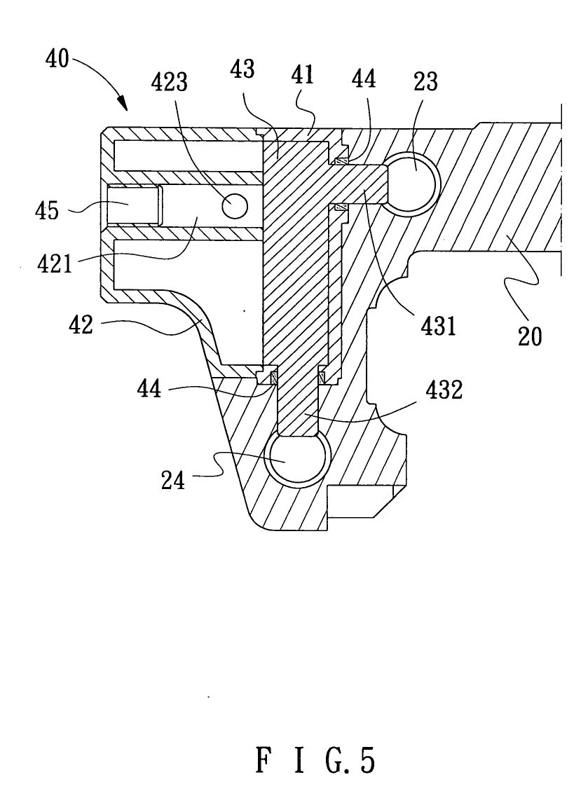

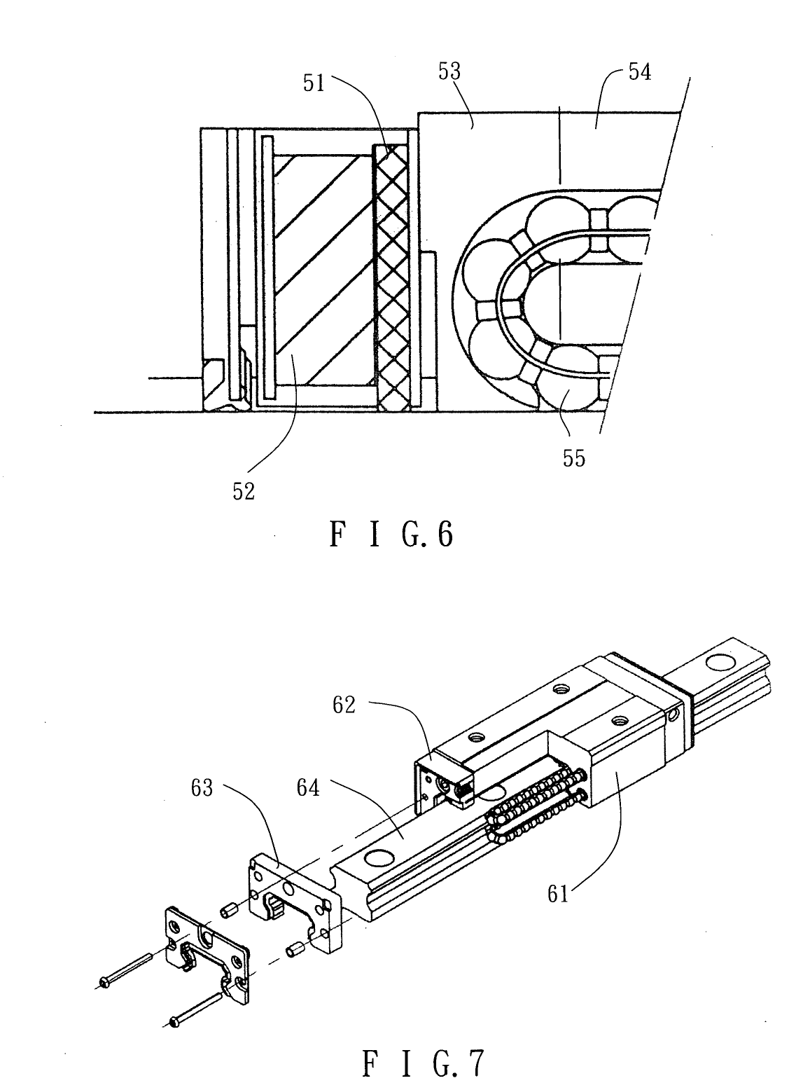

Referring to FIG. 5, which is a cross sectional view taken along with the line A-A in FIG. 2, when the self-lubrication module 40 is fixed to the sliding block 20, the oil-bearing material 43 will absorb the lubricant in the oil-storage space between the front and the rear covers 41, 42, and then the lubricant is introduced into the upper and the lower passages 23, 24 via the upper and the lower flanges 431, 432 of the oil-bearing material 43, so as to lubricate the rollers directly. The oil-seal loop 44 is disposed between the upper and the lower protrusions 411a, 412a and flanges 431, 432, such that the oil-seal effect is improved. In addition, a bolt 45 is disposed in the replenishing pipe 421 so as to prevent leakage of the lubricant in the oil-storage space. The user can unscrew the bolt 45 and replenish lubricant via the replenishing pipe 421. The replenishing pipe 421 is designed as having a proper length for enabling the rollers to be lubricated directly and easily. The replenishing pipe 421 is further defined with oil apertures 423, such that the lubricant can be absorbed by the oil-bearing material 43 while being introduced into the oil-storage space through the oil apertures 423, so as to reduce the time for oil replenishment.

The self-replenishing system for linear guideway in accordace with the present invention has the characteristics as follows:

1. The self-replenishing system for linear guideway of the present invention is of direct lubricating type, not indirect lubricating type, such that the loss lubricant is reduced.

2. The self-replenishing system for linear guideway of the present invention is designed in a manner that the travel space for the sliding block is not affected, so as to save space on the condition that the effective travel of the line guideway is not reduced.

3. It is convenient to replenish the self-replenishing system for linear guideway of the present invention with lubricant, and the time for oil replenishment is reduced.

4. The assembly is easy because the self-replenishing system for linear guideway of the present invention is assembled and disassembled using tongue and groove method and no screw is required.

While we have shown and described various embodiments in accordance with the present invention, it should be clear to those skilled in the art that further embodiments may be made without departing from the scope of the present invention.

1. A lubrication module of linear guideway comprising:
oil-storage box having an oil-storage space defined inside of the oil-storage box for the storage of lubricant; wherein said oil-storage box defined at both sides of sliding block of said linear guideway;
oil-bearing material received in the oil-storage box for absorbing the lubricant in the oil-storage space and the lubricant used to lubricate rollers directly.

2. The lubrication module of linear guideway as claimed in claim 1, wherein the oil-storage box includes a front cover and a rear cover, the oil-storage box is defined with apertures for enabling the oil-bearing material to connect the oil-storage space and the rollers directly.

3. The lubrication module of linear guideway as claimed in claim 2, wherein the front and the rear covers are assembled together by using ultrasonic bonding method.

4. The lubrication module of linear guideway as claimed in claim 2, wherein oil-seal loop is disposed in the respective apertures of the oil-storage box, so as to improve effect of oil-seal.

5. The lubrication module of linear guideway as claimed in claim 2, wherein the apertures of the oil-storage box are peripherally provided with protrusion, so as to position the self-lubrication system.

6. The lubrication module of linear guideway as claimed in claims 1, wherein the oil-storage box is provided with replenishing pipe for easy oil replenishment.

7. The lubrication module of linear guideway as claimed in claims 2, wherein the oil-storage box is provided with replenishing pipe for easy oil replenishment.

8. The lubrication module of linear guideway as claimed in claim 1, wherein the oil-bearing material is hair felt.

9. The lubrication module of linear guideway as claimed in claim 1, wherein the oil-storage box is provided with elastic piece so as to mount on the sliding block in a tongue and groove manner.
